(19) United States
(12) Patent Application Publication
(10) Pub. No.: US 2018/0277888 A1
(43) Pub. Date: Sep. 27, 2018

(54) ELECTRODES FOR METAL ION BATTERIES AND RELATED MATERIALS, BATTERIES AND METHODS

(71) Applicant: Black Silicon Ltd., Grand Cayman (KY)

(72) Inventors: Derek John Fray, Cambridgeshire (GB); Paul Robert Coxon, Cambridge (GB); Hyunkyung Kim, Chungju-si, Chungbuk (KR)

(21) Appl. No.: 15/927,274

(22) Filed: Mar. 21, 2018

(30) Foreign Application Priority Data
Mar. 23, 2017 (GB) 1704586.5

(51) Int. Cl. H01M 10/0525; H01M 2/36; H01M 4/04; H01M 4/38

(52) U.S. Cl. CPC H01M 10/0525; H01M 2/364; H01M 2004/028; H01M 4/386; H01M 4/04

(57) ABSTRACT

A substrate-free, self-supporting and/or binder-free silicon material, as well as related articles, systems and methods are disclosed. The silicon material can have a relatively large empty volume, and/or a relatively low density. Exemplary articles include battery electrodes, such as rechargeable metal ion battery electrodes. Exemplary systems include batteries, such as rechargeable metal ion batteries.

### CROSS-REFERENCE TO RELATED APPLICATION

The present application claims priority from UK Patent Application GB1704586.5, filed Mar. 23, 2017, the entire contents of which are incorporated by reference herein.

### FIELD

The present disclosure relates to a substrate-free, self-supporting and/or binder-free silicon material, as well as related articles, systems and methods. The silicon material can have a relatively large empty volume, and/or a relatively low density. Exemplary articles include battery electrodes, such as rechargeable metal ion battery electrodes. Exemplary systems include batteries, such as rechargeable metal ion batteries.

### BACKGROUND

Rechargeable lithium ion batteries are commonly used in portable electronics and electric and hybrid vehicles. Relative to certain other batteries, rechargeable lithium ion batteries can exhibit a high open circuit voltage, little or no memory effect, and a low self-discharge rate. In some cases, however, lithium ion batteries can exhibit a relatively low capacity and/or a relatively long recharge time.

FIG. 1 shows an exemplary rechargeable lithium ion battery 10 including a lithium-containing anode 12, a cathode 14, an electrolyte 16, a semi-permeable separator 18 that prevents anode 12 and cathode 14 from contacting each other, and a load 20 electrically connected to anode 12 and cathode 14. FIG. 2 shows that, when discharging battery 10 to provide electrical power to load 20, lithium in anode 12 ionizes to form lithium ions 22 and electrons 24. Lithium ions 22 dissolve in electrolyte 16, pass through separator 18, discharge and enter cathode 14 as lithium atoms. Electrons 24 pass through load 20 and combine lithium ions 22 at cathode 14, resulting in lithium intercalated within cathode 14. The net result of discharging battery 10 is movement of lithium from anode 12 to cathode 14. FIG. 3 shows that, when recharging battery 10, essentially the reverse process occurs—electrons 24 move from cathode 14 to load 20 to anode 12, and lithium ions flow from the cathode 14 to the anode 12 where they combine with electrons 24 to provide lithium in anode 12. The net result of charging battery 10 is movement of lithium from cathode 14 to anode 12.

For rechargeable lithium ion batteries, lithium-containing graphite is a common anode material, and lithium cobalt oxide (LiCoO₂) is a common cathode material. In such a rechargeable lithium ion battery, the reactions at the anode and cathode can be represented as follows.

Anode reaction:

LiC₆═Li⁺6C+e⁻

Cathode reaction:

Li⁺+Li_{0.5}CoO₂+e⁻=LiCoO₂

Relevant background information may be available in the following:
M. Winter et al., Advanced Materials, Vol. 10, Issue 10, 725-763 (1998);
R. Das Gupta et al., J. Carbon, Vol. 70, 142-148 (2014);
W. Chen et al., J. Electrochem. Soc., Vol. 158(9), A1055-A1059 (2011);
T. Nohira, Metallurgical and Materials Transactions B, Vol. 49B, 341-348 (2019);

U.S. Pat. No. 6,334,939;

U.S. Pat. No. 6,514,395;

U.S. Pat. No. 9,012,066; and

Published PCT patent application WO2011/161479.

### SUMMARY

The disclosure provides a silicon material that has desirable properties such that it can be advantageously used in an electrode (e.g., an anode) of a rechargeable metal ion battery (e.g., a rechargeable lithium ion battery). As an example, the material can undergo a comparatively large number of charge/discharge cycles while undergoing relatively limited swelling/shrinking, due to the existence of considerable porosity which can absorb the expansion, such that the material does not undergo substantial mechanical degradation or substantial electrical conductivity reduction resulting from mechanical degradation. As another example, the silicon material can combine with lithium in a battery anode (e.g., a rechargeable lithium ion battery anode) to provide an intermetallic material having a higher gravimetric and/or volumetric capacity than graphite. An electrode including the silicon material can exhibit very good electrical properties, while also having a relatively long useful lifetime. Other applications include photovoltaics, removing bacteria from solutions, biological applications and tissue engineering.

The disclosure also provides methods of making such silicon materials. The methods can include first forming the material on a substrate (e.g., a silicon substrate having a silica surface layer), and then removing the material from the substrate (e.g., by scraping or ultrasonic removal). Alternatively, reducing silica particles in a packed or fluidised bed.

As used herein, the term “battery” encompasses a single unit (single cell including an anode, a cathode and a load) or multiple units (multiple cells).

In a general aspect, the disclosure provides a method of using an electrolytic cell that includes an anode, a cathode and a molten salt electrolyte. The cathode includes silica in contact with the molten salt electrolyte. The method includes: applying a potential to the electrolytic cell to reduce the silica without depositing a cation from the molten salt electrolyte at the cathode, thereby providing a silicon material; and removing the silicon material from the support.

In a general aspect, the disclosure provides a method of using an electrolytic cell that includes an anode, a cathode and a molten salt electrolyte. The cathode includes silica supported by a substrate, the silica being in contact with the molten salt electrolyte. The method includes: applying a potential to the electrolytic cell to reduce the silica to provide a silicon material; and removing the silicon material from the substrate. The silicon material includes a mixture of silicon particles and silicon needles.

In some embodiments, the silicon material has an empty volume of at least 50% compared to solid silicon.

In some embodiments, the silicon material has a density of at most 1.16 g/cm³.

In some embodiments, the silicon material is self-supporting, substrate-free and/or binder-free.

In some embodiments, the method further includes using the silicon material to make a battery electrode includes the silicon material.

In some embodiments, the battery electrode is a metal ion battery electrode.

In some embodiments, the battery electrode is an alkali metal ion battery electrode.

In some embodiments, the battery electrode is an electrode selected from the group consisting of a lithium ion battery electrode, a sodium ion battery electrode, and a potassium ion battery electrode.

In some embodiments, the battery electrode is a lithium ion battery electrode.

In some embodiments, the substrate is silicon.

In some embodiments, the method further includes applying silica to the substrate to provide the surface layer of silica.

In some embodiments, the method further includes oxidizing the substrate to provide the surface layer of silica.

In some embodiments, the surface layer of silica further includes an electrically conductive material.

In some embodiments, the silicon material does not contain an additional electrically conductive material.

In some embodiments, such as, for example when used as a battery electrode, the silicon material can be coated with graphene.

In some embodiments, recovering the silicon material includes removing the silicon material from the substrate.

In some embodiments, removing the silicon material from the substrate includes at least one process selected from the group consisting of mechanically removing the silicon material from the substrate and ultrasonically removing the silicon material from the substrate.

In some embodiments, the silicon material includes a mixture of silicon needles and silicon particles.

In some embodiments, the silicon needles have an average diameter of less than 1×10⁻⁶ m.

In some embodiments, the silicon needles have an average length of less than 1×10⁻⁵ m.

In some embodiments, the silicon needles have an aspect ratio of at least 5:1.

In some embodiments, the silicon particles have an average diameter of less than 1×10⁻⁶ m.

In some embodiments, the silicon particles have an average diameter of less than 1×10⁻⁷ m.

In some embodiments, the silicon material includes clusters of the silicon particles.

In some embodiments, the mixture of the silicon needles and the silicon particles is self-supporting.

In some embodiments, the mixture of the silicon powder and the silicon particles is binder-free.

In some embodiments, the mixture of the silicon powder and the silicon particles is substrate-free.

In some embodiments, the cathode further includes an electrical conductor in electrical contact with the silica, such as silica particles.

In some embodiments, the cathode further includes silicon powder mixed with the silicon particles.

In some embodiments, the molten salt electrolyte is liquid at a temperature from 500° C. to 1000° C.

In some embodiments, the molten salt electrolyte includes a halide of calcium, barium, strontium or lithium.

In some embodiments, the molten salt electrolyte consists of a halide of calcium, barium, strontium or lithium.

In some embodiments, the molten salt electrolyte includes calcium chloride.

In some embodiments, the anode is a carbon (e.g., graphite) anode or an inert anode.

In some embodiments, the anode is a member selected from the group consisting of: tin oxide, doped with antimony oxide and copper oxide; calcium ruthenate in calcium titanate; ruthenium oxide and titanium dioxide; nickel ferrite; a nickel based alloy; an iron based alloy; and an iron nickel alloy.

In some embodiments, using the silicon material to make a battery electrode includes depositing the silicon material on a current collector. The current collector can include carbon paper including carbon microfibers. Depositing the silicon material on the current collector can include casting a slurry on the current collector. The slurry includes the silicon material. The silicon material can be deposited on the current collector without using a binder.

In a general aspect, the disclosure provides a method of manufacturing an electrode for a battery. The method includes: i) providing an electrolytic cell including an anode, a cathode and a molten salt electrolyte, the cathode including silica in contact with the molten salt electrolyte; ii) applying a potential to the electrolytic cell to reduce the silica without depositing a cation from the molten salt electrolyte at the cathode, with reduction of the silica forming a silicon reaction product; iii) recovering the silicon reaction product from the electrolytic cell; and iv) using the recovered silicon reaction product to form at least part of the electrode for a metal ion battery.

In some embodiments, the silica is a surface layer on a substrate.

In some embodiments, the substrate includes silicon.

In some embodiments, the method further includes forming the surface layer of silica by coating the substrate with silica.

In some embodiments, the method further includes forming the surface layer of silica by oxidizing the substrate.

In some embodiments, recovering the silicon reaction product includes removing the silicon reaction product from the substrate.

In some embodiments, the silicon reaction product can be coated with graphene.

In some embodiments, the silicon reaction product is removed from the substrate mechanically or ultrasonically.

In some embodiments, the silica includes silica particles.

In some embodiments, the cathode further includes silicon particles mixed with the silica particles.

In some embodiments, the molten salt electrolyte is at a temperature from 500° C. to 1000° C.

In some embodiments, the molten salt electrolyte includes or consists of a halide of calcium, barium, strontium or lithium.

In some embodiments, the molten salt electrolyte is calcium chloride.

In some embodiments, the anode of the electrolytic cell is a carbon (e.g., graphite) anode or an inert anode.

In some embodiments, the electrolytic cell has an inert anode selected from the group consisting of: tin oxide, doped with antimony oxide and copper oxide; calcium ruthenate in calcium titanate; ruthenium oxide and titanium dioxide; nickel ferrite; a nickel based alloy; an iron based alloy; and an iron nickel alloy.

In some embodiments, the silicon reaction product includes an intimate mixture of silicon particles and silicon needles.

In some embodiments, the silicon needles have an average diameter of less than 1×10⁻⁶ m and an average length of less than 1×10⁻⁵ m.

In some embodiments, the silicon particles have an average diameter of less than 1×10⁻⁶ m.

In some embodiments, the silicon particles and silicon needles are sufficiently entwined in the intimate mixture that the intimate mixture is self-supporting.

In some embodiments, using the silicon reaction product includes depositing the recovered reaction product on a current collector.

In some embodiments, the current collector includes carbon paper that includes carbon microfibers.

In some embodiments, the recovered silicon reaction product is deposited on the current collector by forming a slurry that includes the recovered silicon reaction product and casting the slurry on the current collector.

In some embodiments, the recovered silicon reaction product deposited on the current collector attaches itself to the current collector without a binder.

In a general aspect, the disclosure provides a material obtainable by any of the methods disclosed herein.

In a general aspect, the disclosure provides a battery electrode that includes a material obtainable by any method disclosed herein.

In some embodiments, the electrode is an anode.

In some embodiments, the electrode is a rechargeable metal ion battery anode.

In some embodiments, the electrode is a rechargeable alkali metal ion battery anode.

In some embodiments, the electrode is an electrode selected from the group consisting of a rechargeable lithium ion battery anode, a rechargeable sodium ion battery anode, and a rechargeable potassium ion battery anode.

In some embodiments, the electrode is a rechargeable lithium metal ion battery anode.

In some embodiments, the electrode further includes carbon (e.g., graphite), and/or the electrode includes a graphene coating.

In a general aspect, the disclosure provides a battery that includes: an anode that includes a material obtainable by any method disclosed herein; a cathode including an active material capable of releasing and re-adsorbing metal and/or metal ions during battery discharge and recharge; and an electrolyte between the anode and the cathode.

In some embodiments, the battery is a rechargeable metal ion battery.

In some embodiments, the battery is a rechargeable alkali metal ion battery.

In some embodiments, the battery is a battery selected from the group consisting of a rechargeable lithium ion battery, a rechargeable sodium ion battery, and a rechargeable potassium ion battery.

In some embodiments, the battery is a rechargeable lithium metal ion battery.

In some embodiments, after its first lithiation/delithiation cycle, the battery has a lithiation/delithiation profile that changes by less than 5% for 50 lithiation/delithiation cycles.

In some embodiments, the battery has a specific capacity that is at least 90% of its theoretical specific capacity.

In some embodiments, the battery has a capacity retention of at least 90% after 50 lithiation/delithiation cycles.

In some embodiments, the battery is a rechargeable battery.

In some embodiments, the anode further includes carbon (e.g., graphite), and/or the anode includes a graphene coating.

In a general aspect, the disclosure provides a material that includes a mixture of silicon particles and silicon needles. At least one (e.g., at least two, at least three, at least four, each) of the following holds: the mixture of silicon particles and silicon needles has an empty volume of at least 50% compared to solid silicon, and/or the material has a density of at most 1.16 g/cm³; the silicon needles have an average diameter of less than 1×10⁻⁶ m; the silicon needles have an average length of less than 1×10⁻⁵ m; the silicon needles have an aspect ratio of at least 5:1; and the silicon particles have an average diameter of less than 1×10⁻⁶ m. In addition, at least one (e.g., each) of the following holds: the mixture of silicon particles and silicon needles is self-supporting and/or substrate-free; and the mixture of silicon particles and silicone needles is binder-free.

In some embodiments, the silicon material includes clusters of the silicon particles.

In some embodiments, the mixture of silicon particles and silicon needles is configured to combine with metal atoms formed by the discharge of metal ions.

In some embodiments, the mixture of silicon particles and silicon needles is configured to combine with alkali metal atoms formed by the discharge of alkali metal ions.

In some embodiments, the mixture of silicon particles and silicon needles is configured to combine with metal atoms formed by the discharge of metal ions selected from the group consisting of lithium atoms, sodium atoms and potassium atoms.

In some embodiments, the mixture of silicon particles and silicon needles can be coated with graphene.

In a general aspect, the disclosure provides a battery electrode that includes a material that includes a mixture of silicon particles and silicon needles. At least one (e.g., at least two, at least three, at least four, each) of the following holds: the mixture of silicon particles and silicon needles has an empty volume of at least 50% compared to solid silicon, and/or the material has a density of at most 1.16 g/cm³; the silicon needles have an average diameter of less than 1×10⁻⁶ m; the silicon needles have an average length of less than 1×10⁻⁵ m; the silicon needles have an aspect ratio of at least 5:1; and the silicon particles have an average diameter of less than 1×10⁻⁶ m. In addition, at least one (e.g., each) of the following holds: the mixture of silicon particles and silicon needles is self-supporting and/or substrate-free; and the mixture of silicon particles and silicone needles is binder-free.

In some embodiments, the electrode is an anode.

In some embodiments, the electrode is a rechargeable metal ion battery anode.

In some embodiments, the electrode is a rechargeable alkali metal ion battery anode.

In some embodiments, the electrode is an electrode selected from the group consisting of a rechargeable lithium ion battery anode, a rechargeable sodium ion battery anode, and a rechargeable potassium ion battery anode.

In some embodiments, the electrode is a rechargeable lithium metal ion battery anode.

In some embodiments, the electrode for molten salt electrolysis further includes carbon (e.g., graphite), and/or the electrode includes a graphene coating.

In some embodiments, the electrode for molten salt electrolysis further includes a member selected from the group consisting of: tin oxide, doped with antimony oxide and copper oxide; calcium ruthenate in calcium titanate; ruthenium oxide and titanium dioxide; nickel ferrite; a nickel based alloy; an iron based alloy; and an iron nickel alloy, and/or the electrode includes a graphene coating.

In a general aspect, the disclosure provides a battery that includes an anode includes a material including a mixture of silicon particles and silicon needles. At least one (e.g., at least two, at least three, at least four, each) of the following holds: the mixture of silicon particles and silicon needles has an empty volume of at least 50% compared to solid silicon, and/or the material has a density of at most 1.16 g/cm³; the silicon needles have an average diameter of less than 1×10⁻⁶ m; the silicon needles have an average length of less than 1×10⁻⁵ m; the silicon needles have an aspect ratio of at least 5:1; and the silicon particles have an average diameter of less than 1×10⁻⁶ m. In addition, at least one (e.g., each) of the following holds: the mixture of silicon particles and silicon needles is self-supporting and/or substrate-free; and the mixture of silicon particles and silicone needles is binder-free. The battery also includes a cathode that includes an active material capable of releasing and re-adsorbing metal and/or metal ions during battery discharge and recharge, and an electrolyte between the anode and the cathode.

In some embodiments, the battery is a rechargeable metal ion battery.

In some embodiments, the battery a rechargeable alkali metal ion battery.

In some embodiments, the battery is a battery selected from the group consisting of a rechargeable lithium ion battery, a rechargeable sodium ion battery, and a rechargeable potassium ion battery.

In some embodiments, the battery is a rechargeable lithium metal ion battery.

In some embodiments, after its first lithiation/delithiation cycle, the battery has a lithiation/delithiation profile that changes by less than 5% for 50 lithiation/delithiation cycles.

In some embodiments, the battery has a specific capacity that is at least 90% of its theoretical specific capacity.

In some embodiments, the battery has a capacity retention of at least 90% after 50 lithiation/delithiation cycles.

In some embodiments, the battery is a rechargeable battery.

In some embodiments, the anode further includes carbon (e.g., graphite), and/or the anode includes a graphene coating.

### BRIEF DESCRIPTION OF THE DRAWINGS

Exemplary embodiments are described herein with reference to the accompanying figures, in which:

FIG. 1 is a cross-sectional view of an embodiment of a rechargeable lithium ion battery;

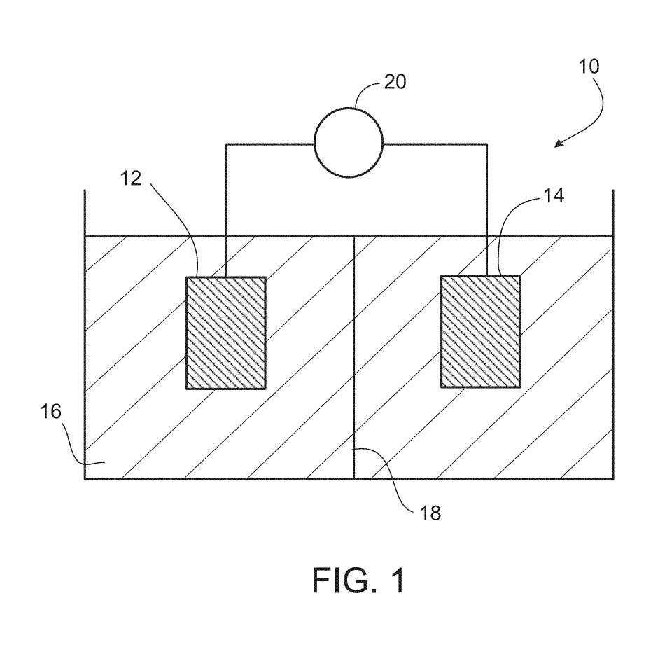

FIG. 2 is a cross-sectional view of the process of discharging the lithium ion battery of FIG. 1;

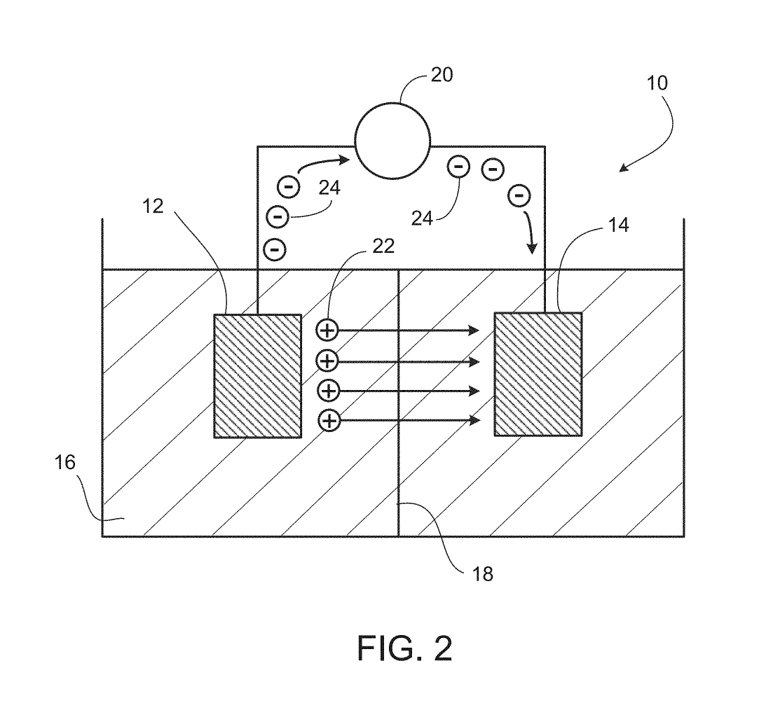

FIG. 3 is a cross-sectional view of the process of charging the lithium ion battery of FIG. 1;

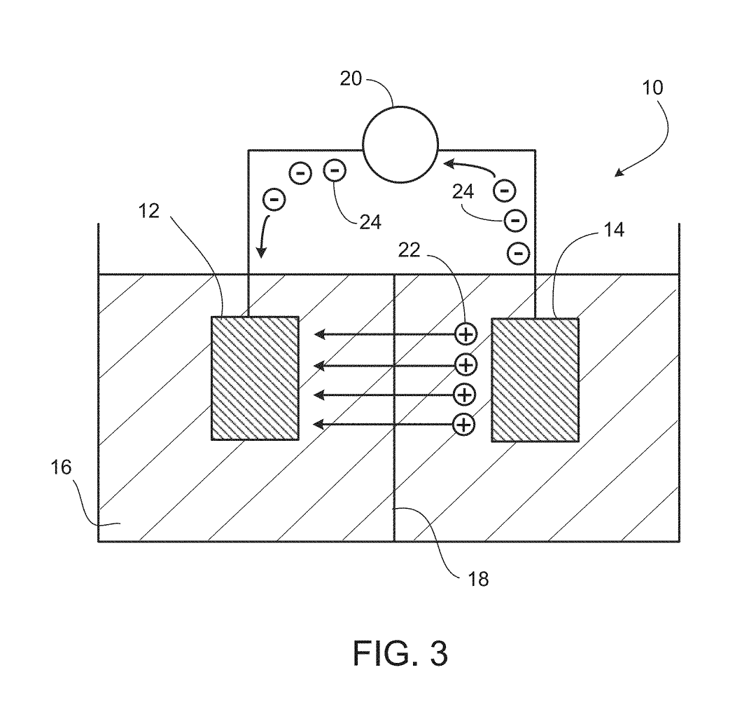

FIG. 4 is a cross-sectional view of an arrangement for making the silicon material disclosed herein;

FIG. 5 is an electron micrograph showing the structure of the silicon material disclosed herein;

FIG. 6 is an electron micrograph showing the surface of silicon material disclosed herein;

FIG. 7 is a graph showing discharge/charge profiles during the 50^{th} cycling of a rechargeable lithium ion battery including an anode including a silicon electrode;

FIG. 8 is a graph showing specific capacity and Coulombic efficiency of a rechargeable lithium ion battery including a silicon electrode; and

FIG. 9 is a graph showing specific capacity as a function of cycle number for several current densities for a rechargeable lithium ion battery including a silicon electrode.

### DETAILED DESCRIPTION

The silicon material disclosed herein is a generally porous mixture of silicon needles and silicon particles, with the silicon particles and silicon needles being sufficiently entwined in the mixture that the material is self-supporting. The material may be substrate-free (removed from a substrate on which the material was formed). As such, the material be used, for example, as a battery electrode without including a binder (binder-free material). The material may be capable of combining with atoms of, for example, lithium.

The silicon material can have a large empty volume and be substantially less dense compared to solid silicon. As used herein, the term “solid silicon” refers to silicon having a density of 2.32 g/cm³. In some embodiments, compared to a given volume of solid silicon, the same volume of silicon material disclosed herein at least 50% (e.g., at least 60%, at least 70%, at least 80, at least 90%, at least 95%, at least 96%) empty, i.e., devoid of solid. In certain embodiments, the silicon material disclosed herein has a density of at most 1.16 g/cm³ (e.g., 0.9 g/cm³, 0.7 g/cm³, 0.5 g/cm³, 0.25 g/cm³, 0.1 g/cm³).

The silicon needles may have an average diameter of 1×10⁻⁶ meter or less (e.g., 500 nanometers or less) and an average length of 1×10⁻⁵ meter or less (e.g., five microns or less). The silicon needles may have an aspect ratio of 5:1 or more (e.g., 10:1 or more). Typically, the silicon needles are wetted by the molten salt.

The silicon particles may have an average diameter of 1×10⁻⁶ meter or less (e.g., 1×10⁻⁷ meter or less). Typically, the silicon particles are wetted by the molten salt.

The silicon particles may be in the form of clusters.

The silicon material disclosed herein can be used as the electrode (e.g., anode) of a battery (e.g., a rechargeable metal ion battery, such as a rechargeable lithium ion battery). Such an electrode (e.g., anode) containing the silicon material disclosed herein can be used in a battery, such as a rechargeable metal ion battery (e.g., a rechargeable lithium ion battery). The silicon material may contain a binder or may be binder-free. Optionally, the silicon material may include an electrically conductive material, such as, for example, graphene and/or electrically conductive particles which may form separate phases. In some embodiments, the silicon material is doped with an n-type conductor (e.g., phosphorus, arsenic, antimony, bismuth) and/or a p-type conductor (e.g., boron, aluminium, gallium). In some embodiments, the silicon material can be coated with graphene.

A battery (e.g., a rechargeable metal ion battery, such as a rechargeable lithium ion battery) containing an anode that includes the silicon material can exhibit various advantageous properties. As an example, a rechargeable metal ion battery (e.g., a rechargeable lithium ion battery) containing an anode that includes the silicon material can have change of less than 5% (e.g., less than 2%, less than 1%) in its lithiation/delithiation profile for 50 lithiation/delithiation cycles after its first lithiation/delithiation cycle. As another example, a rechargeable metal ion battery (e.g., a rechargeable lithium ion battery) containing an anode that includes the silicon material can have a specific capacity that is at least 90% (e.g., at least 95%, at least 98%) of its theoretical specific capacity. As a further example, a rechargeable metal ion battery (e.g., a rechargeable lithium ion battery) containing an anode that includes the silicon material can have a capacity retention of at least 90% (e.g., at least 95%, at least 98%) after 50lithiation/delithiation cycles.

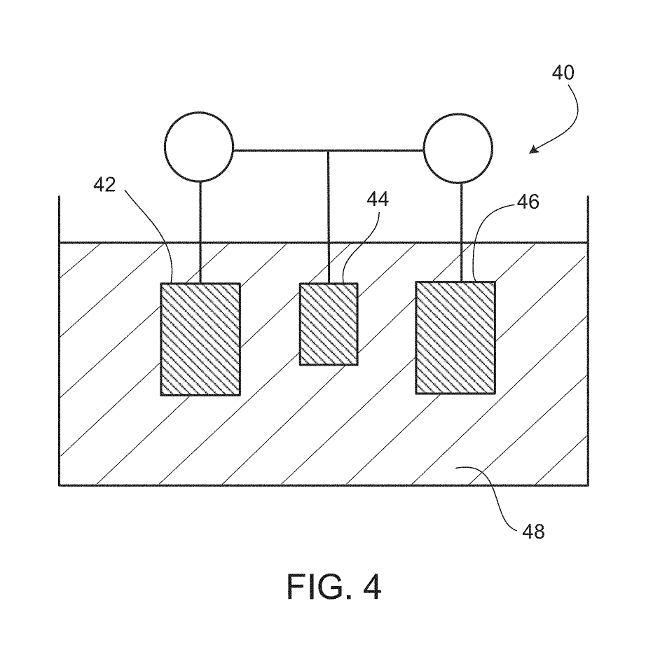

FIG. 4 shows an arrangement 40 that can be used to make the silicon material disclosed herein. Arrangement 40 includes a counter electrode 42, a cathode 44, a reference electrode 46 (the reference electrode is usually smaller than anode or cathode), and a molten salt electrolyte 48 in which electrodes 42, 44 and 46 are disposed.

In some embodiments, counter electrode 42 and/or reference electrode 46 is a graphite electrode. In certain embodiments, counter electrode 42 and/or reference electrode 46 is an inert anode, such as, for example: tin oxide, doped with antimony oxide and copper oxide; calcium ruthenate in calcium titanate; ruthenium oxide and titanium dioxide; nickel ferrite; a nickel based alloy; an iron based alloy; or an iron nickel alloy containing aluminum.

Cathode 44 includes a silicon substrate with a surface layer of silica. The silica layer can be formed, for example, via the electrochemical oxidation of the surface of the silicon substrate or by deposition of silica on the silicon substrate or naturally in air. Cathode 44 is in contact with an electrical conductor (e.g., a molybdenum frame) that is electrically connected to counter electrode 42 and reference electrode 46. Optionally, the silica surface layer contains an electrically conductive dopant so that the resulting silicon material has enhanced electrical conductivity (e.g., for use in a battery electrode). Exemplary electrically conductive dopants include n-type dopants and p-type dopants.

In general, molten salt electrolyte 48 has a melting point of from 500° C. to 1000° C.

Preferably, the molten salt electrolyte dissolves oxygen ions to allow transfer of oxygen from cathode 44 into molten salt electrolyte 48 and then to the anode. Molten salt electrolyte 48 may include, for example, a halide of calcium, barium, strontium or lithium. The halide may be a chloride. An exemplary molten salt electrolyte is calcium chloride (CaCl₂).

The method of making the silicon material includes heating the molten salt electrolyte (e.g., to a temperature about 100° C. above its melting point), and applying a cathodic potential so that the silica surface layer is reduced to yield the silicon material and oxygen ions, as indicated below.

SiO₂+4e⁻=2O²⁻+Si (silicon material)

The oxygen ions diffuse to counter electrode 42 were they are discharged. When electrode 42 is formed of graphite, the result is carbon dioxide. When electrode 42 is an in inert electrode, the result is oxygen gas rather than carbon dioxide or carbon monoxide. The microstructure of the silicon material produced by this method is an intimate mixture of silicon particles and silicon needles. If the original silicon was doped with an n-type dopant or a p-type dopant, or alloyed with electrically conducting metal, the product would contain the corresponding electrically conductive material (n-type dopant, p-type dopant, or metal addition) and would exhibit enhanced electrical conductivity.

After producing the silicon material, cathode 54 is removed, and the silicon material is removed from the substrate. In some embodiments, the silicon material is scraped off of the substrate. In certain embodiments, the silicon material is removed from the substrate ultrasonically.

After removal from the substrate, the silicon material may be deposited onto a current collector to provide an electrode. The current collector may be formed, for example, of carbon paper including carbon microfibers. In some embodiments, the silicon material is formed into a slurry, and the slurry is cast onto the current collector. As noted above, the silicon material be binder-free, and/or it may contain one or more additional electrically conductive materials. Optionally, the silicon material is mixed with graphite and/or graphene before deposition on the current collector. Such mixing may include coating at least some of the silicon particles and/or needles in the intimate mixture. In some embodiments, a graphene coating is applied.

The resulting battery can be used as an anode in a rechargeable lithium ion battery that further includes a cathode, a separator and an electrolyte.

### EXAMPLES

Formation of Silicon Material

CaCl₂ was used as the electrolyte, and was prepared as follows. Analytical grade anhydrous CaCl₂ was subjected to a vacuum and a heating schedule (80° C. for 3 hours, 120° C. for 3 hours and 180° C. for 18 hours) at a temperature below its melting point to remove residual water without the CaCl₂ reacting with water to form CaO. The resulting CaCl₂ was put into in an alumina crucible (height of 100 mm, wall thickness three mm) to a depth of four cm. The crucible containing the CaCl₂ was placed inside a stainless steel reactor in a vertical tube furnace (Instron SFL, UK). The salt was melted at 850° C. The electrolyte was purified by pre-electrolysis using three cylindrical graphite rods, which served as working, pseudo-reference and counter electrodes. The purification was performed for 20 hours at polarization ΔE=−1.0 V vs. the graphite pseudo-reference electrode.

P-type silicon wafers sliced from a <100> single-crystal were used (from Si-Mat GmbH, Germany). The diameter of the wafer was about five cm), and the geometric area 22.8 cm². The thickness was −275.+−0.25 μm, and the resistivity was from one to 30 ohm/cm. The wafers were coated with a thermal oxide layer having an average thickness was 2.0243 μm. One side of the specimen was polished. The samples were attached to a molybdenum rod (0.5 mm) frame that served as an electrical conductor. Rectangular specimens (5 cm²) were prepared from the wafer using a diamond knife and mechanical breaking.

A graphite cylindrical rod was used as the reference electrode, and another graphite rod was used as the counter electrode. The graphite electrodes were calibrated by measuring the potential for calcium deposition. This was at about −1.5 V and exhibited good reproducibility.

Cyclic polarization measurements for a molybdenum electrode indicated the onset of calcium deposition (Ca²⁻+2e→Ca) below E of about −1.5 V vs. graphite. Silica reduction starts at a much more positive potentials, roughly, +0.9 V vs. E°_{Ca}_{²⁺}_{/Ca} or −0.6 V versus graphite. To deoxygenate the silica layer, potentiostatic electrolysis was performed at E=−1.0 V to −1.25 V vs. graphite, which was appropriate to reduce silica and prevent calcium co-deposition. Electrochemical reduction of solid oxides in molten salts occurs at a three-phase interface lines (3PIs). The initial three-phase interface was composed from the electronic conductor (Mo), the oxide (SiO₂) and the electrolyte (CaCl₂). The molybdenum wire attached to silica surface played the role of current collector. The electrochemical silicon reduction starts at the interface Mo—SiO₂—CaCl₂.

SiO₂+4e⁻→Si+2O²⁻

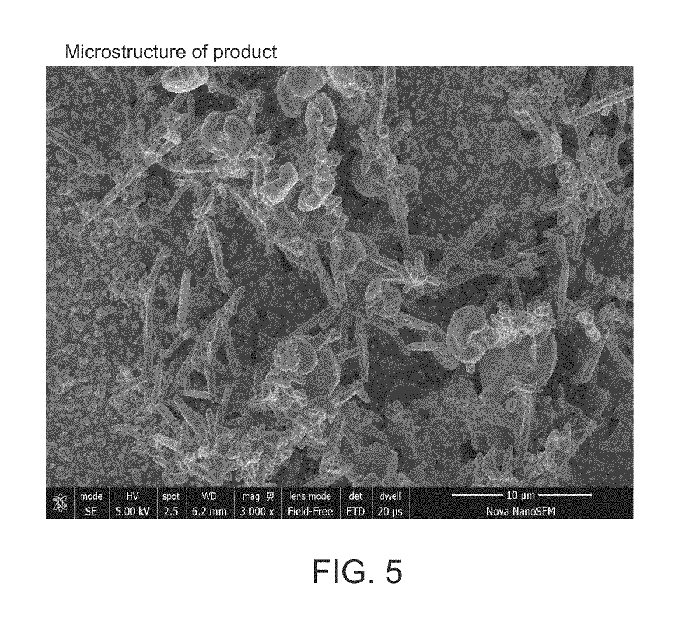

The oxygen ions were removed by diffusion to electrolyte and the produced silicon takes a further role of an electronic conductor by forming a new three-phase interface Si—SiO₂—CaCl₂. As a result, propagation of the reduction area and formation of thin silicon film was possible. Once the reduced silicon or other areas of silicon, which has been reduced from silica, contacted the silicon substrate, the entire wafer started to act as an electronic conductor. After a short time, the surface of the silicon disc turned black, indicating that a fine surface structure was created. The surface layer was in the range of 10 nm to 10 microns in depth was harvested, after the disk has been removed from the salt, by scraping or by the application of ultrasonic dispersion. As shown in FIG. 5, the structure included a mass of needles with irregular surfaces and some needles containing right angles which physically interact to hold structure together. The background dots are attributed to the support (silicon substrate).

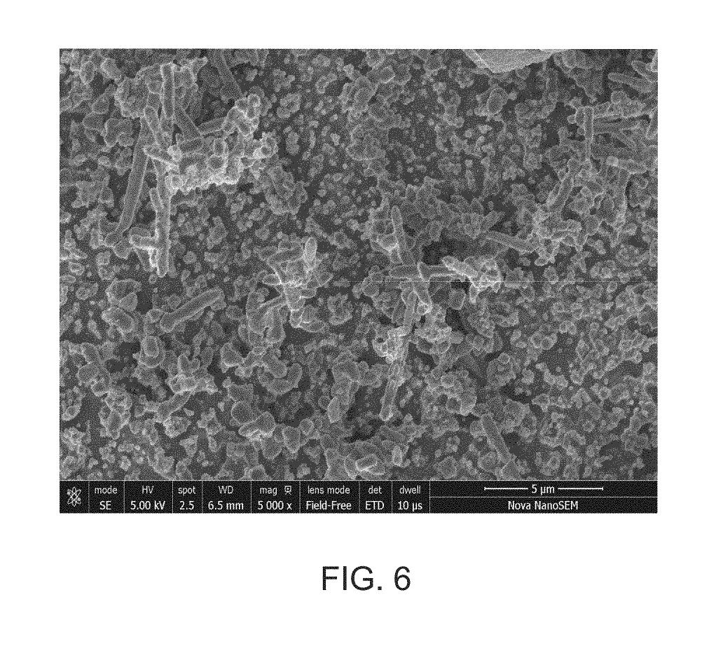

The silicon material was derived from a series of wafers produced by reduction in molten CaCl₂ salt at −0.9 V versus graphite for 1 hour. A scanning electron micrograph (SEM) image of the wafer after reduction is shown in FIG. 6, and reveals the randomised pitted and porous surface layer made up from clusters of silicon particles mixed with silicon needles with substantial porosity (open volume). The needles were approximately 500 nm in diameter and up to five microns in length. The depth of the porous layer was approximately 10 microns and yielded approximately 2.328 mg of silicon powder per cm². Thus under these reaction conditions a standard 10 cm diameter wafer yielded approximately 182 mg of powder of the silicon material.

Silica powder in a bed or a fluidised bed could also be reduced by inserting a cathode into the bed.

Making Anodes

The electrochemical properties of the silicon material was investigated using 2032-type coin cells with a lithium foil counter electrode and 1 M LiPF₆ in ethylene carbonate (EC)/dimethyl carbonate (DMC), 50/50 (v/v) as the electrolyte. The working electrode was fabricated via sonication of the silicon material on the silicon substrate in Dimethylformamide (DMF) solution and drop cast on a carbon paper. 10×1 cm² wafers were used to provide the active anode material. Each working electrode had a surface area of 1.13 cm², and the density of active material in the electrode was approximately 1-2 mg/cm².

Galvanostatic charge-discharge is a technique where a constant current density is applied and responsive potential is measured as a function of time. In most full cells, the device is initially charged (i.e. the anode was lithiated) to a preset potential and the discharge process is monitored. The process of lithiation in the anode is considered to be “discharging” for a half cell. The specific capacities of all the electrodes were calculated from the total masses of silicon, and their electrochemical characteristics were measured within a 0.01-2.5 V range using a potentiostat/galvanostat (Land CT2001A).

Results

The electrochemical properties of the silicon electrode were measured in the potential range 0.01 V-2.5 V using a 2032-type coin cell with lithium foil as the counter electrode and 1 M LiPF₆ in ethylene carbonate (EC)/dimethyl carbonate (DMC), 50/50 (v/v) as electrolyte. The specific capacities of the anodes made with the silicon material-containing electrode were calculated on the basis of the masses of silicon material in the electrode.

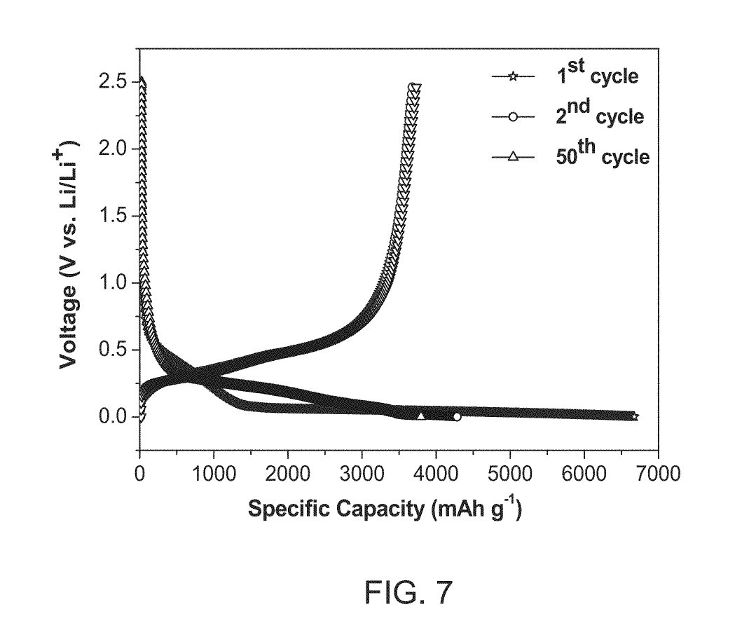

The lithiation (discharge)/ delithiation (charge) voltage profiles during the 50^{th} cycling, are shown in FIG. 7. The first cycle exhibited a discharge and charge capacity of 6660 mAh g⁻¹ and 3645 mAh g⁻¹, respectively, and the Coulombic efficiency for the 1^{st} cycle was 54.7% when tested at a constant current density of 0.05 C-rate. This was likely due to the irreversible lithium reaction that results in the formation of a solid electrolyte interface (SEI) layer on the electrode surface and the increase consumption of lithium ions in the composite via the structural defects in the first lithiation process. After the second charge/discharge cycle, the long-range plateau, evident in the profile after the first lithiation stage, changed into a sloping plateau, owing to the electrochemical amorphization of the crystalline silicon. This effect can be reduced by coating the silicon particles with sheets of graphene so that the graphene interacts with the electrolyte, rather than the silicon. The lithiation/delithiation profile did not change during the subsequent 50^{th} cycles, demonstrating that this electrode possessed a stable conducting framework during the electrochemical reactions of electrode.

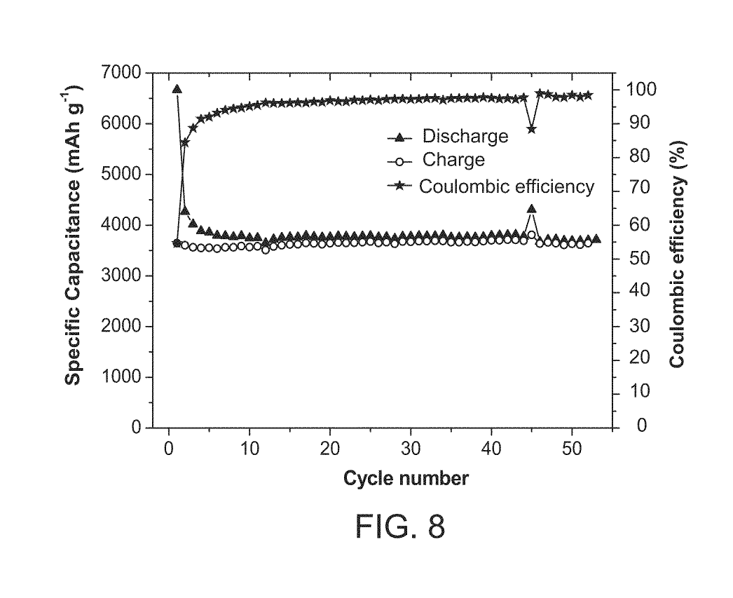

FIG. 8 shows the lithiation/delithiation specific capacities at 0.05 C-rate and Coulombic efficiency during cycling for the silicon electrode, and the results demonstrate a highly stable performance. A capacity of 3680 mAhg⁻¹ was retained after 50 charge/discharge cycles, and the capacity retention relative to the capacity value in the 50^{th} cycle was around 100%, which pointed to the absence of capacity loss and a slightly incremented capacity during cycling. Furthermore, the Coulombic efficiency increased significantly from 54.7% (first cycle) to up to 98% during further cycling.

The results demonstrate that the electrode formed with the silicon material produces a substantially stable conducting network with a desirable free volume network for accommodating the Si expansion during the alloying/de-alloying process. Without wishing to be bound by theory, it is believed that, in general, during the first lithiation process, silicon undergoes an approximate volume expansion of 400% because of the formation of a Li—Si alloy phase. This level of volume expansion might normally cause the electrode to lose contact and consequently increase the electrical resistance of the electrode. It is believed that the electrically conducting needle type silicon structures in the electrode may produce a more stable electrically conducting network than an electrode based on a different form of silicon. It is also believed that the electrically conducting and free volume network structure of the silicon material described herein was better maintained even after the first lithiation process, and was accompanied by a 400% increase in the silicon volume but not in the volume of the electrode due the extra volume being absorbed by the porosity. Therefore, it is further believed that, during the subsequent delithiation process, the highly electrically conducting electrode containing the silicon material disclosed herein could exhibit a low capacity loss because of its stable electrically conducting network, which resulted in a higher electronic conductivity and advantageous free volume network, thereby confirming that the highly electrically conducting electrode formed of the silicon material described herein provided an efficient electrically conducting/buffering framework as an electrode.

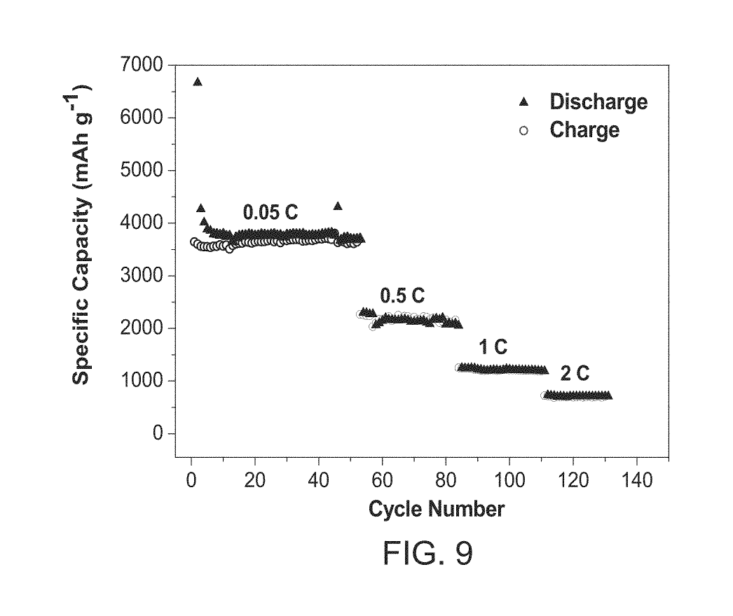

The lithiation/delithiation capacities of the electrode containing the silicon material described herein at various current densities ranging from 0.05 to 2 C-rate are shown in FIG. 9. The delithiation capacities were 3699, 2054, 1187, and 711 mAhg⁻¹ at 0.05 (after 52 cycles), 0.5 (after 83 cycles), 1 (after 110 cycles), and 2 C-rate (after 130 cycles), respectively. The battery containing the silicon electrode not only exhibited enhanced specific capacity (almost theoretical capacity), cyclability but also has a good rate capability when the current density is increased. This result confirmed that the silicon electrode is effective in providing a higher electronic conductivity and necessary free volume network. These values compare very favorably with 372 mAh/g for graphite anodes.

1. (canceled)

2. A method of using an electrolytic cell comprising an anode, a cathode and a molten salt electrolyte, the cathode comprising silica supported by a substrate, the silica being in contact with the molten salt electrolyte, the method comprising:
applying a potential to the electrolytic cell to reduce the silica to provide a silicon material; and
removing the silicon material from the substrate,
wherein the silicon material comprises a mixture of silicon particles and silicon needles.

3. The method of claim 2, wherein the silicon material has an empty volume of at least 50% compared to solid silicon, and/or the silicon material has a density of at most 1.16 g/cm³.

4. The method of claim 2, wherein, after removal from the substrate, the silicon material is self-supporting, substrate-free and/or binder-free.

5. The method of claim 2, wherein the substrate comprises silicon.

6.-9. (canceled)

10. The method claim 2, wherein removing the silicon material comprises removing the silicon material from the substrate.

11.-13. (canceled)

14. The method of claim 2, wherein the silicon needles have an average length of less than 1×10⁻⁵ m.

15. The method of claim 14, wherein the silicon needles have an aspect ratio of at least 5:1.

16. The method of claim 15, wherein the silicon particles have an average diameter of less than 1×10⁻⁶ m.

17.-18. (canceled)

19. The method of claim 2, wherein the mixture of the silicon needles and the silicon particles is self-supporting and/or substrate-free.

20. The method of claim 2, wherein the mixture of the silicon needles and the silicon particles is binder-free.

21.-29. (canceled)

30. The method of claim 2, further comprising, after removing the silicon material, using the silicon material to make a battery electrode comprising the silicon material.

31. The method of claim 30, wherein the battery electrode comprises a metal ion battery electrode.

32.-38. (canceled)

39. A method of manufacturing an electrode for a battery, the method comprising:
i) providing an electrolytic cell including an anode, a cathode and a molten salt electrolyte, the cathode comprising silica in contact with the molten salt electrolyte;
ii) applying a potential to the electrolytic cell to reduce the silica without depositing a cation from the molten salt electrolyte at the cathode, with reduction of the silica forming a silicon reaction product;
iii) recovering the silicon reaction product from the electrolytic cell; and
iv) using the recovered silicon reaction product to form at least part of the electrode for a metal ion battery.

40.-81. (canceled)

82. A material, comprising:
a mixture of silicon particles and silicon needles,
wherein:
i) at least one of the following holds:
the mixture of silicon particles and silicon needles has an empty volume of at least 50% compared to solid silicon, and/or the material has a density of at most 1.16 g/cm³;
the silicon needles have an average diameter of less than 1×10⁻⁶ m;
the silicon needles have an average length of less than 1×10⁻⁵ m;
the silicon needles have an aspect ratio of at least 5:1;
the silicon particles have an average diameter of less than 1×10⁻⁶ m; and
ii) at least one of the following holds:
the mixture of silicon particles and silicon needles is self-supporting and/or substrate-free; and
the mixture of silicon particles and silicone needles is binder-free.

83. The material of claim 82, wherein at least two of the following hold:
the mixture of silicon particles and silicon needles has an empty volume of at least 50% compared to solid silicon, and/or the material has a density of at most 1.16 g/cm³;
the silicon needles have an average diameter of less than 1×10′ m;
the silicon needles have an average length of less than 1×10⁻⁵ m;
the silicon needles have an aspect ratio of at least 5:1; and
the silicon particles have an average diameter of less than 1×10⁻⁶ m.

84. The material of claim 82, wherein at least three of the following hold:
the mixture of silicon particles and silicon needles has an empty volume of at least 50% compared to solid silicon, and/or the material has a density of at most 1.16 g/cm³;
the silicon needles have an average diameter of less than 1×10⁻⁶ m;
the silicon needles have an average length of less than 1×10⁻⁵ m;
the silicon needles have an aspect ratio of at least 5:1;
the silicon particles have an average diameter of less than 1×10⁻⁶ m.

85. The material of claim 82, wherein at least four of the following hold:
the mixture of silicon particles and silicon needles has an empty volume of at least 50% compared to solid silicon, and/or the material has a density of at most 1.16 g/cm³;
the silicon needles have an average diameter of less than 1×10⁻⁶ m;
the silicon needles have an average length of less than 1×10⁻⁵ m;
the silicon needles have an aspect ratio of at least 5:1;
the silicon particles have an average diameter of less than 1×10⁻⁶ m.

86. The material of claim 82, wherein each the following hold:
the mixture of silicon particles and silicon needles has an empty volume of at least 50% compared to solid silicon, and/or the material has a density of at most 1.16 g/cm³;
the silicon needles have an average diameter of less than 1×10⁻⁶ m;
the silicon needles have an average length of less than 1×10⁻⁵ m;
the silicon needles have an aspect ratio of at least 5:1;
the silicon particles have an average diameter of less than 1×10⁻⁶ m.

87.-91. (canceled)

92. The material of claim 82, wherein the mixture of silicon particles and silicon needles is self-supporting and/or substrate-free.

93. The material of claim 82, wherein the material is coated with graphene.

94.-97. (canceled)

98. An electrode, comprising:
the material according to claim 82,
wherein the electrode comprises a battery electrode.

99.-105. (canceled)

106. A battery, comprising:
an anode comprising the material according to claim 82;
a cathode comprising an active material capable of releasing and re-adsorbing metal and/or metal ions during battery discharge and recharge; and
an electrolyte between the anode and the cathode.

107.-110. (canceled)

111. The battery of claim 106, wherein, after its first lithiation/delithiation cycle, the battery has a lithiation/delithiation profile that changes by less than 5% for 50 lithiation/delithiation cycles.

112. The battery of claim 106, wherein the battery has a specific capacity that is at least 90% of its theoretical specific capacity.

113. The battery of claim 106, wherein the battery has a capacity retention of at least 90% after 50 lithiation/delithiation cycles.

114.-116. (canceled)
